(19) United States
(12) Patent Application Publication
(10) Pub. No.: US 2004/0218757 A1
(43) Pub. Date: Nov. 4, 2004

(54) Structure of wrong insertion preventive RJ45 telecom jack

(76) Inventor: Chien Hsiang Teng, Pingjen City (TW)

Correspondence Address: NATH & ASSOCIATES, Sixth Floor, 1030 - 15th Street, N.W., Washington, DC, 20005, US

(21) Appl. No.: 10/425,643

(22) Filed: Apr. 30, 2003

(51) Int. Cl. H04M 1/00; H04M 9/00

(52) U.S. Cl. 379/438

(57) ABSTRACT

Present invention relative to a structure of wrong insertion preventive RJ45 telecom jack that consists of components such as a telecom jack module, a plastic body, foolproof leaf springs, and a metal shelter. In light of the fact that a RJ12-6P plug is often inserted into a socket of the RJ45 jack installed in a communication or consumer product, the foolproof structure of RJ45 telecom jack is used in present invention to prevent the wrong insertion of the RJ12-6P plug and to ensure the proper connection of the RJ45-8P with the RJ45 telecom jack. In this way, it is possible to protect all communication and consumer products loaded with RJ45 telecom jacks. Consequently, consumers can use these products safely without concerning themselves with damaging the products by inserting the RJ12-6P plug improperly.

### FIELD OF THE INVENTION

Present invention provides a structure of wrong insertion preventive RJ45 telecom jack that is mainly intended for preventing the currently common problem of connection between a RJ45 telecom jack and a RJ12-6P plug. Foolproof leaf springs are used to prevent the wrong insertion of the RJ12-6P plug, thereby fulfilling the function of wrong insertion prevention. In doing so, it is possible to ensure the proper connection of the RJ45-8P plug with RJ45 telecom jack and to prevent the wrong insertion of the RJ12-6P plug into the RJ45 telecom jack. The foolproof leaf springs can be installed in two ways: directly formed into the metal shelter of the telecom jack, or separately mounted on one side or both sides inside the socket of the telecom jack. In this way, the wrong insertion preventive RJ45 telecom jack can achieve its economic efficiency properly.

### PRIOR ART

In a common RJ45 telecom jack, a socket is provided on the front for the insertion of a RJ45-8P plug into the RJ45 telecom jack, thereby the cooperation between the plug and the socket of the RJ45 telecom jack. However, the wrong insertion of a RJ12-6P plug into the socket of the RJ45 telecom jack used often occurs since the width of the socket can accommodate the RJ12-6P plug of a smaller width and no foolproof device against the insertion of the RJ12-6P plug is provided structurally.

The structure of the RJ12-6P plug is not applicable for the RJ45 jack. In the case of wrong insertion, the non-groove bottoms of the RJ12-6P plug may cause the contact leaf springs on both sides inside the RJ45 jack to descend and deform because of the pushing pressure. If a correct plug for the RJ45 jack (i.e. a RJ45-8P plug) is subsequently inserted, the RJ45 jack cannot work normally due to the poor connection between the contact leaf springs and the RJ45-8P plug. This has a negative impact on the overall functionality of communication and consumer products because they cannot work normally due to signal disconnection.

### SUMMARY OF THE INVENTION

In light of the aforementioned, the inventor has developed based on years of experiences the foolproof leaf springs on the RJ45 telecom jack as provided in the invention for preventing the wrong insertion of the RJ12-6P plug. The width difference between the RJ45-8P and RJ12-6P plugs is taken into consideration in the design of the foolproof leaf springs. The front ends of the foolproof leaf springs cannot be pressed down by the bottoms of both sides of the RJ12-6P plug. This successfully prevents the RJ12-6P from advancing into the RJ45 jack. In contrast, the RJ45-8P plug of the correct width can press down the foolproof leaf springs properly. This ensures the proper connection between the RJ45 telecom jack and the RJ45-8P plug for the purpose of normal transmission of communication and consumer products due to proper signal connection.

### BRIEF DESCRIPTION OF DRAWINGS

FIG. 1 shows mainly consists of components such as a telecom jack module, a plastic body, a metal shelter and a structure of foolproof leaf springs.

FIG. 2 shows position of the foolproof leaf springs before it is assembled.

FIG. 3 shows position of the foolproof leaf springs are inserted into both sides of the plastic body after it was assembled.

FIG. 4 shows position of all components of present invention were assembled.

FIG. 5 shows top section view of all components of present invention were assembled.

FIG. 6 shows position of the RJ12-6P plug is inserted into the RJ45 telecom jack of present invention.

FIG. 7 shows top section view of the RJ12-6P plug is inserted into the RJ45 telecom jack of present invention.

FIG. 8 shows side section view of the foolproof leaf springs hold the sides of the front end of the RJ12-6P plug of present invention.

FIG. 9 shows perspective view of a correct plug (i.e. a RJ45-8P plug) is inserted into a RJ45 jack of present invention.

FIG. 10 shows top section view of a correct plug (i.e. a RJ45-8P plug) is inserted into a RJ45 jack of present invention.

FIG. 11 shows side section view of correct plug (i.e. a RJ45-8P plug) press down the foolproof leaf springs of present invention.

FIG. 12 shows position of the foolproof leaf springs can be installed directly formed into the metal shelter of the telecom jack.

### DETAILED DESCRIPTION OF THE PREFERRED EMBODIMENTS

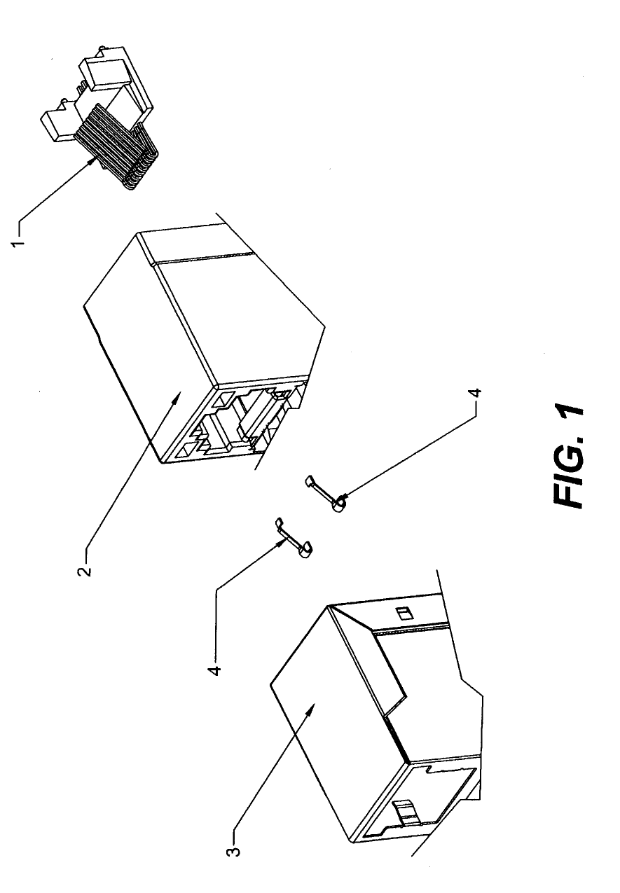

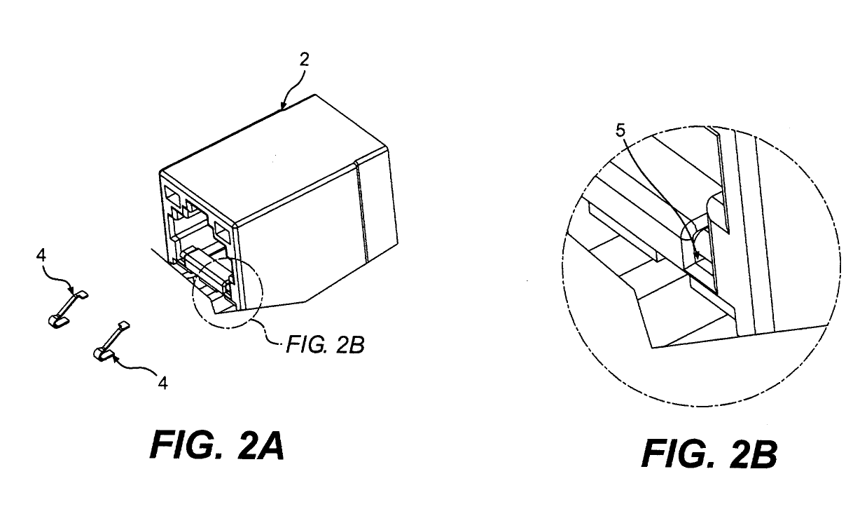

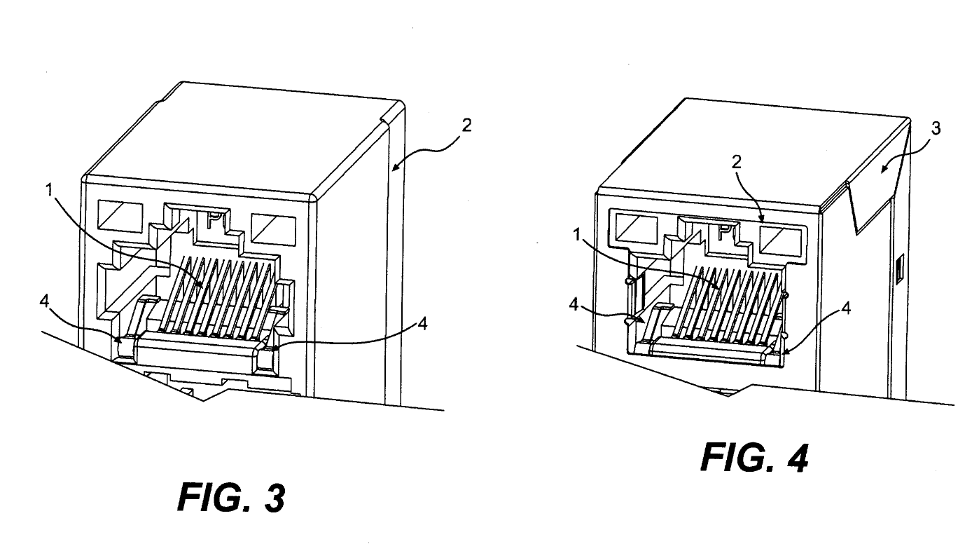

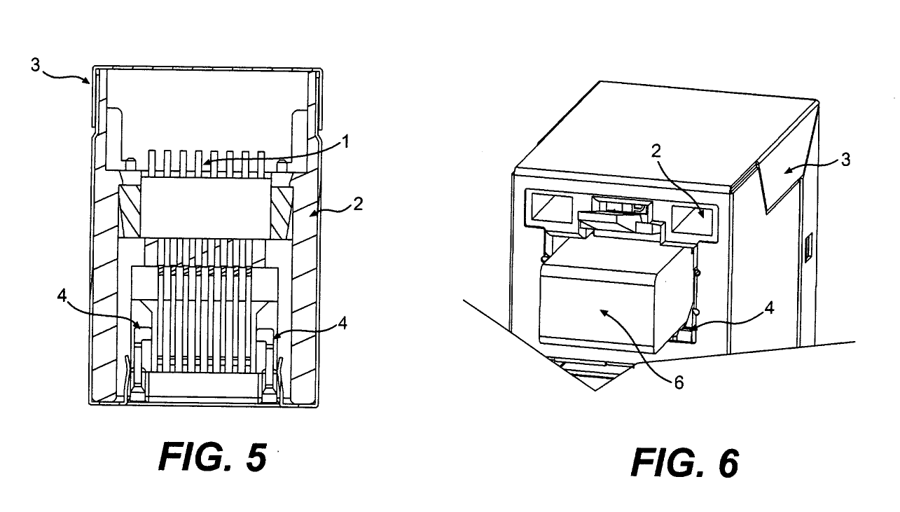

Present invention relative to a structure of wrong insertion preventive RJ45 telecom jack as shown in FIGS. 4 and 5. It mainly consists of components such as a telecom jack module (1), a plastic body (2), a metal shelter (3) and a structure of foolproof leaf springs (4) (see FIG. 1). The foolproof leaf springs (4) are made of elastic metal and one-piece formed with compression and bending. The foolproof leaf springs (4), formed in a particular shape and angle, have projecting grabbing dots on the top that serve as obstacles and their bottoms are so shaped that the foolproof leaf springs fit the corresponding grooves of the plastic body (2) of the RJ45 telecom jack for alignment. First, the pre-assembled telecom jack module (1) is inserted into the plastic body (2) and secured. Then, the foolproof leaf springs (4) are inserted into both sides of the plastic body (2) (see FIG. 3). Finally, the metal shelter (3) is put on the plastic body (2) and secured by fastening the securing flaps on the side covers and the securing holes on the side plates.

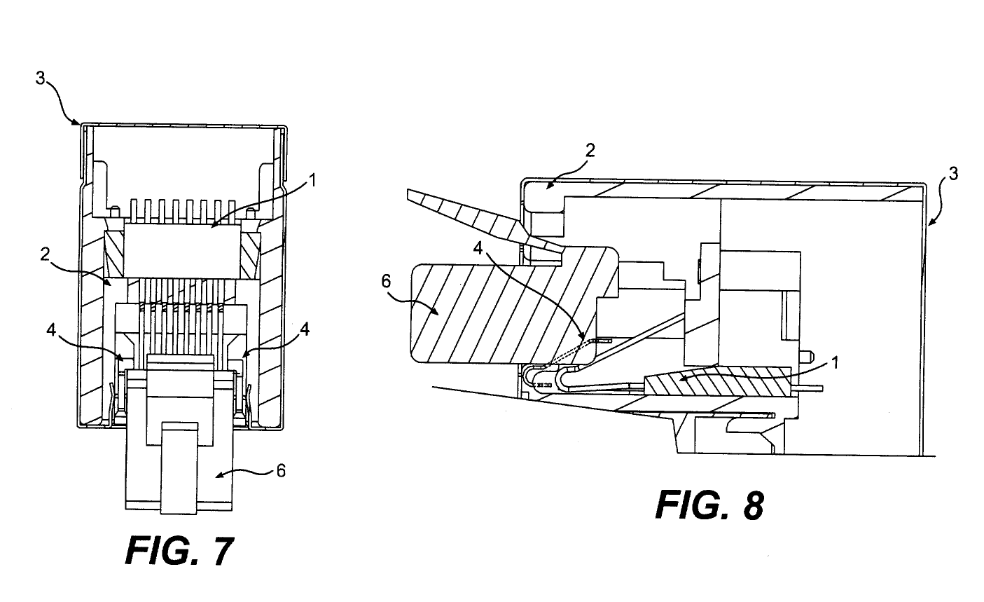

The foolproof leaf springs (4) work based on the following theory. The width of the RJ12-6P plug (5) is about 9.65 mm and smaller compared to that of the RJ45-8P plug, which is about 11.68 mm. Therefore, the front ends of the foolproof leaf springs (4) cannot be pressed down by the bottoms of both sides of the RJ12-6P plug (6) due to its insufficient width when the RJ12-6P plug (6) is inserted into the RJ45 telecom jack (see FIGS. 6, 7 and 8). The projecting grabbing dots on the tops of the foolproof leaf springs (4) then hold the sides of the front end of the RJ12-6P plug (6) and prevent the RJ12-6P plug from advancing into RJ45 jack, thereby successfully protecting the contact leaf springs inside the RJ45 jack.

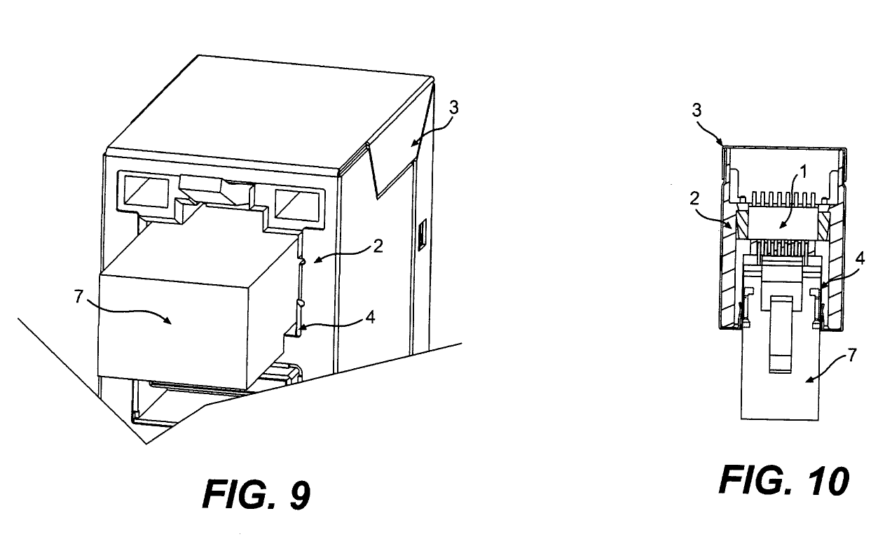

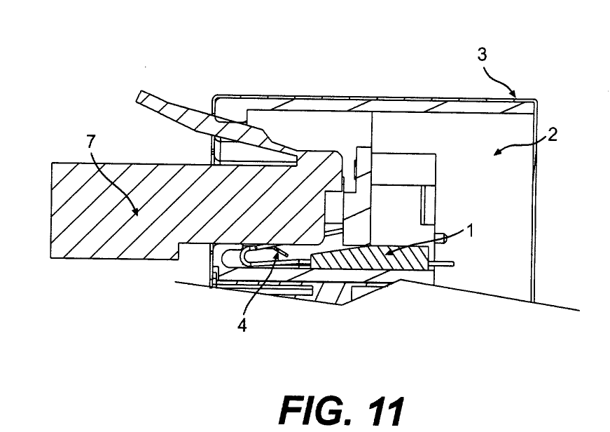

In the contrast, when a correct plug (i.e. a RJ45-8P plug) is inserted into a RJ45 jack with the foolproof leaf springs (4) of this invention, the correct width of the RJ45-8P plug (7) allows it to press down the front ends and the projecting grabbing dots on the tops of the foolproof leaf springs (4) properly so that they are under the bottom of the RJ45-8P plug (7). In this case, the plastic front end of the RJ45-8P plug is not held by the projecting grabbing dots on the tops of the foolproof leaf springs (4), thus the RJ45-8P plug (7) properly connects with the RJ45 telecom jack (see FIGS. 9, 10 and 11). In the case of separating the RJ45-8P plug (7) from the RJ45 jack loaded with the foolproof leaf springs (4), the plastic bottom of the RJ45-8P plug (7) can be successfully separated from the foolproof leaf springs (4). The foolproof leaf springs (4) then resume to their original position with their existing elasticity so that they can prevent the wrong insertion of the RJ12-6P plug all the time.

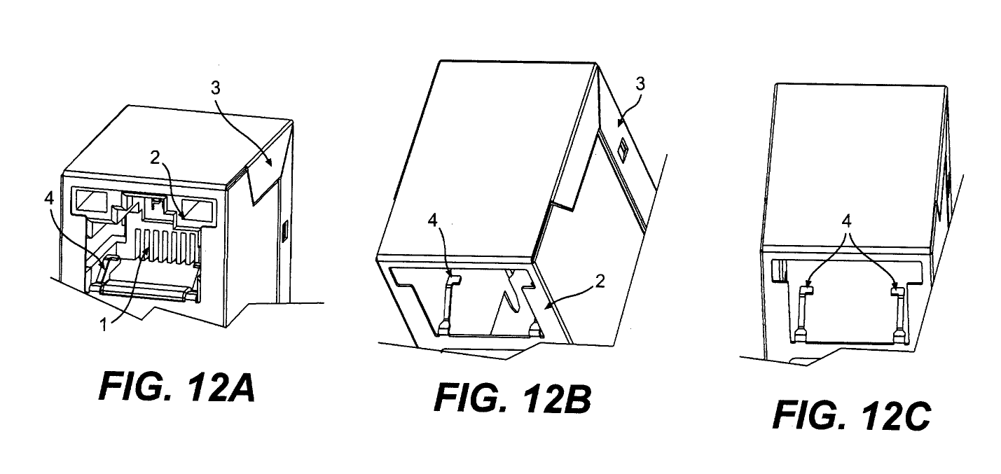

Moreover, the foolproof leaf springs (4) can be installed separately on one side or both sides inside the socket of the telecom jack, or directly formed into the metal shelter of the telecom jack (3) (see FIG. 12). The structure of wrong insertion preventive RJ45 telecom jack can be a single-port composition, or an extended multi-port or double layer port structure. The combination can be applied to RJ45 jacks of different angles and forms. To sum up, the aforesaid embodiment serves only as an example of this invention and is by no means intended for limiting this invention. Within the scope of the spirit of this invention, all variations, modifications and applications initiated by those familiar with this art shall be included in the range of this invention. A patent application concerning this invention—a structure of wrong insertion preventive RJ45 telecom jack is filed since the invention meets all the requirements for such application.

What is claimed is:

1. The structure of wrong insertion preventive RJ45 telecom jack that consists of components such as a telecom jack module, a plastic body, a metal shelter and foolproof leaf springs and is characterized in that:
First, the pre-assembled telecom jack module is inserted into the plastic body and secured; then, the foolproof leaf springs are inserted into both sides of the plastic body; and finally, the metal shelter is put on the plastic body and secured by fastening the securing flaps on the side covers and the securing holes on the side plates.

2. The structure of wrong insertion preventive RJ45 telecom jack of claim 1 wherein it is further characterized in that the foolproof leaf springs are made of elastic metal and one-piece formed with compression and bending; and the foolproof leaf springs, formed in a particular shape and angle, have projecting grabbing dots on the top that serve as obstacles and their bottoms are so shaped that the foolproof leaf springs fit the corresponding grooves of the plastic body of the RJ45 telecom jack for alignment.

3. The structure of wrong insertion preventive RJ45 telecom jack of claim 1 wherein it is further characterized in that the foolproof leaf springs can be installed separately or directly formed into the metal shelter of the telecom jack.

4. The structure of wrong insertion preventive RJ45 telecom jack of claim 1 wherein it is further characterized in that the foolproof leaf springs can be installed on one side or both sides inside the socket of the telecom jack.

5. The structure of wrong insertion preventive RJ45 telecom jack of claim 1 wherein it is further characterized in that the structure of wrong insertion preventive RJ45 telecom jack can be a single-port composition, or an extended multi-port or double layer port structure.

6. The structure of wrong insertion preventive RJ45 telecom jack of claim 1 wherein it is further characterized in that the RJ45-8P plug, when connected with the foolproof leaf springs, can press down the front ends and the projecting grabbing dots on the tops of the foolproof leaf springs properly until they are under the bottom of the RJ45-8P plug; and the plastic bottom of the RJ45-8P plug can be successfully separated from the foolproof leaf springs; and the foolproof leaf springs resume to their original position afterwards.

7. The structure of wrong insertion preventive RJ45 telecom jack of claim 1 wherein it is further characterized in that the projecting grabbing dots on the tops of the foolproof leaf springs (4) then hold the sides of the front end of the RJ12-6P plug (6) and prevent the RJ12-6P plug from advancing into RJ45 jack, thereby the wrong insertion of the RJ12-6P into the RJ45 telecom jack; whereas, the correct width of the RJ45-8P plug allows it to press down the foolproof leaf springs properly, thereby ensuring the proper connection of the RJ45 telecom jack with the RJ45-8P plug.

8. The structure of wrong insertion preventive RJ45 telecom jack of claim 1 wherein it is further characterized in that the combination of the foolproof leaf springs and the plastic body can be applied to RJ45 jacks of different angles and forms.
